(19) United States
(12) Patent Application Publication
(10) Pub. No.: US 2015/0286839 A1
(43) Pub. Date: Oct. 8, 2015

(54) METHODS, SYSTEMS, AND APPARATUS TO PROTECT CONTENT BASED ON PERSONA

(71) Applicants: Omer Ben-Shalom, Rishon Le-Zion (IL); Avishai Goldberg, Kiryat Ono (IL); Alex Nayshtut, Gan Yavne (IL)

(72) Inventors: Omer Ben-Shalom, Rishon Le-Zion (IL); Avishai Goldberg, Kiryat Ono (IL); Alex Nayshtut, Gan Yavne (IL)

(21) Appl. No.: 14/359,604

(22) PCT Filed: Dec. 2, 2013
(86) PCT No.: PCT/US13/72625

§ 371 Date: May 21, 2014

(51) Int. Cl. G06F 21/62

(52) U.S. Cl. CPC G06F 21/6245; G06F 21/6227

(57) ABSTRACT

Example methods, systems, apparatus and articles of manufacture to protect content based on persona are disclosed. An example system includes a content encryption manager to encrypt a first content with an unencrypted first content key in response to identifying a first persona mode of a computing device, a persona encryption manager to encrypt the unencrypted first content key with a first public key to generate an encrypted first content key, and a metadata integrator to embed the encrypted first content key into the encrypted first content.

### FIELD OF THE DISCLOSURE

The present disclosure relates generally to content protection and, more particularly, to methods, systems and apparatus to protect content based on persona.

### BACKGROUND

Often times, a user may use an electronic computing device for different purposes and/or in different capacities. For example, a user may use a laptop computer as an employee (e.g., at an office or a home office), and may use the same laptop computer for personal use (e.g., at home). Many electronic computing devices may also be shared by multiple users, where different users of a device may have preferred configurations of applications on the electronic computing device.

### BRIEF DESCRIPTION OF THE DRAWINGS

FIG. 1 illustrates an example system implemented in accordance with the teachings of this disclosure to provide persona aware content protection.

FIG. 2 is an illustration of an example implementation of the example content manager of FIG. 1.

FIG. 3 is a flowchart representative of example machine readable instructions that may be executed to implement the example content manager of FIGS. 1 and/or 2.

FIG. 4 is another flowchart representative of example machine readable instructions that may be executed to implement the example content manager of FIGS. 1 and/or 2.

FIG. 5 is a schematic illustration of an example processing platform that may execute the example machine readable instructions of FIGS. 3 and/or 4 to implement the example content manager of FIGS. 1 and/or 2.

### DETAILED DESCRIPTION

Computing devices may be used by different users in different capacities, different contexts, and/or for different purposes. For example, a family may have a computer that is shared between adults and children. The children may enjoy playing games, visiting websites for young audiences, enjoying media content attractive to young audiences, etc. The adults, on the other hand, may use the system to read news, perform accounting, watch movies in the evening, etc. In some examples, different users of a computing device may have content that they do not wish to share with the other users of the computing device. For example, the adults may wish to block content (e.g., accounting software) from the children. As used herein, content refers to applications, programs, files, application programming interfaces, etc., available for access and/or use by a user via a computing device.

Computing devices may also be used by a single user in different capacities, different contexts, and/or for different purposes. In some examples, a user may use a laptop computer as an employee (e.g., at an office or a home office), and may use the same laptop computer for personal use (e.g., at home). In some examples, a user may use a laptop computer as an employee for a first company, and may use the same laptop computer as an employee for a second company. Consultants, for example, may have any number of clients and perform consulting services at different client facilities (e.g., client offices, client laboratories, client factories, etc.). In such examples, it may be undesirable for the user to access content associated with the second company while the user acts as an employee for the first company.

To manage access to content and/or computing devices, some traditional computing systems provide a profile-based approach that allows a computing device particular access to content based on different profiles. However, such profile-based systems require a user to “log out” as one user and to “log in” as a second user, or require two separate operating system instances to operate simultaneously. For example, some systems employ virtualization techniques to explicitly provide separate containers of execution, in which one or more hypervisors must manage duplicate and separate virtual resources (operating systems, word processing/spreadsheet applications, etc.) on a single hardware platform. Generally speaking, requiring the same user to “log out” of a first profile (e.g., a first username/password account of an operating system) and “log in” to a second profile (e.g., a second username/password account of the same operating system) facilitates a separation of computing device resources and/or files. Such systems may be burdensome on the user and/or the computing resources.

Examples disclosed herein protect content and enable dynamic changes in computing device and/or content access based on detected active personas. As used herein, a “persona” defines the capacity and/or context in which a user uses a computing device, an operational state/mode of the computing device, and/or the type of access the user is given to content while operating under that “persona.” For example, a user may have a “home” persona that enables the computing device to access personal content (e.g., the computing device is in a home persona mode), and the user may also have a “work” persona that enables the computing device to access work-related (e.g., confidential) content (e.g., the computing device is in a work persona mode). In such examples, both persona types may be associated with a same or different sensitivity (e.g., a same or different “level of trust”), but access to content and/or resources by the computing device may depend on the capacity in which the user is using the computing device. Additionally, particular access privileges may be required by corporate, government, and/or other legal considerations.

Examples disclosed herein enable dynamic changes in access capabilities and/or privileges of a computing device to protect content associated with a persona from access by other personas (e.g., users of the computing device in an alternate operational state) using the computing device. Examples disclosed herein protect content and enable dynamic changes in content access and/or computing device resource access without requiring users to log out or log in to different profiles and without creating isolation between different computing environments (e.g., via virtualization), which may be time consuming, resource intensive, and/or expensive. While example methods, apparatus, systems and/or articles of manufacture disclosed herein refer to an ability to detect and/or otherwise differentiate between different personas, such detection and/or differentiation techniques are beyond the scope of this disclosure. Nonetheless, methods, systems, apparatus and/or articles of manufacture to detect and/or differentiate personas are described in U.S. patent application Ser. No. 13/630,076, entitled, “Multi-Persona Computing Based on Real Time User Recognition,” which is hereby incorporated herein by reference in its entirety.

To protect content and enable dynamic changes in computing device and/or content access based on active personas, examples disclosed herein facilitate a hierarchical protection system using content keys and persona keys associated with personas. In some examples, content associated with a persona is protected with one or more content keys. For example, each application, program, and/or file associated with a persona is protected with a content key. In some examples, the content keys are symmetrical content keys that may be used to both encrypt and/or decrypt the content. The content keys are then protected using persona keys, such as public encryption persona keys associated with a particular persona, as described in further detail below.

In some examples, to protect content keys, public encryption persona keys and corresponding private decryption persona keys are used. In some examples, a content key is encrypted using a public encryption persona key. Thus, prior to being able to use the encrypted version of the content key for purposes of encryption or decryption of content, a private decryption persona key corresponding to the public encryption persona key must be used to decrypt the encrypted content key.

When a persona is deemed active at a computing device (e.g., when it is determined that a user is using a computing device as a “work” persona (work persona mode), such as by way of example methods, apparatus, systems and/or articles of manufacture disclosed in U.S. patent application Ser. No. 13/630,076), examples disclosed herein enable access to a private decryption persona key for the detected active persona. The persona private decryption key is used to decrypt content keys associated with the detected active persona, and the content keys may then be used to access the content (e.g., decrypt the content to a clear text file for use in an application, such as a word processing application) for the active persona.

When a different active persona (which may be the same human individual) is detected at the computing device (e.g., when it is determined that a user is using a computing device as a “home” persona versus the previous “work” persona example), examples disclosed herein cause the previously used private decryption persona key to be unavailable to one or more portions of the computing device. As a result of prohibiting access to and/or otherwise blocking the access to private decryption persona keys associated with the previously active persona, corresponding content associated with the previously active persona is protected from the user associated with the newly detected active persona.

Examples disclosed herein enable functional access to a private decryption persona key for the newly detected active persona. As used herein, “access” of a key refers to possession of the key as distinguished from “functional access” to a key, which may permit a benefit of key use and/or application (e.g., for encryption/decryption purposes) absent actual possession of the key itself by a user or by the computing system. The private decryption persona key for the newly detected active persona is used to decrypt content keys associated with the newly detected active persona to enable access to content associated with the newly detected active persona.

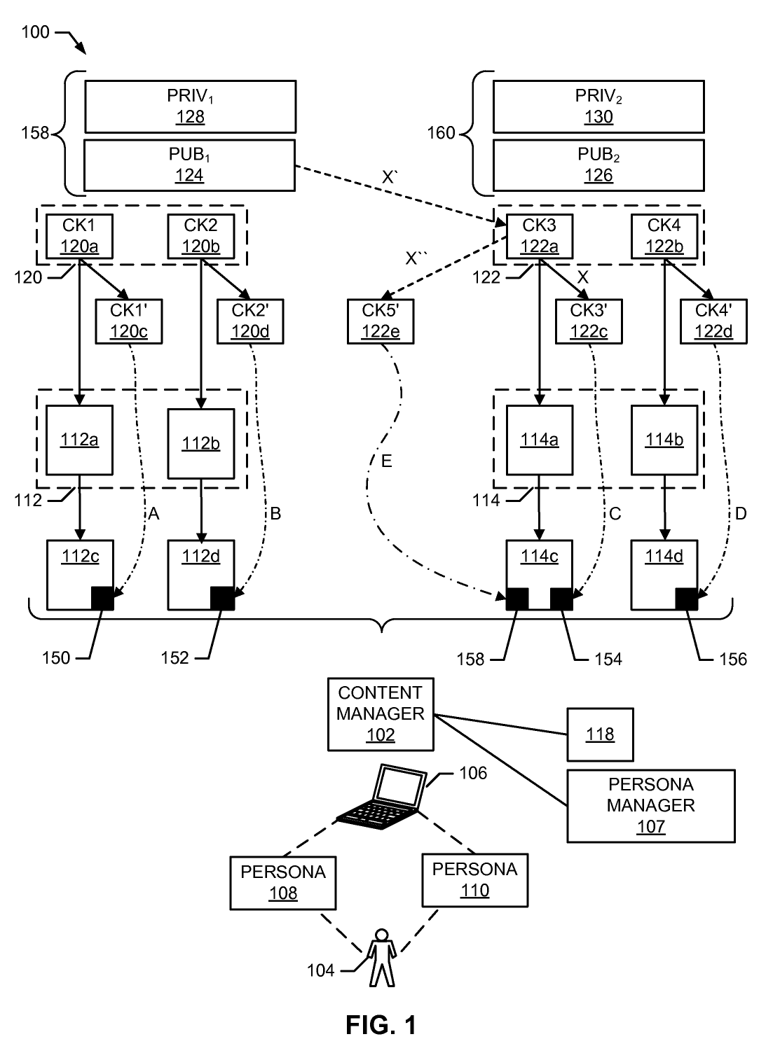

FIG. 1 illustrates an example system 100 including an example content manager 102 implemented in accordance with the teachings of this disclosure to protect content based on persona. The example content manager 102 provides persona aware content protection to enable an example computing device 106 to access particular content associated with one or more different personas.

In the illustrated example of FIG. 1, a user 104 uses the computing device 106 as a first persona 108 or a second persona 110. As described above, a persona reflects an operational state or mode of the example computing device 106, in which a currently active persona is detected by an example persona manager 107. As also described above, detection and/or differentiation of which persona is active is disclosed in U.S. patent application Ser. No. 13/630,076, which is hereby incorporated herein by reference in its entirety. The first persona 108 may be, for example, a “work” persona, and the second persona 110 may be, for example, a “home” persona. Users (e.g., the user 104) may be associated with any number of personas. In some examples, the user 104 may be associated with the first persona 108, and a different user may be associated with the second persona 110. For example, the users may be different humans associated with different personas (e.g., a “parent” persona and a “child” persona, respectively).

The computing device 106 of the illustrated example is a laptop computer. However, the computing device 106 may be any electronic computing device such as a personal computer, a mobile device (e.g., a smartphone), a tablet, etc.

The first persona 108 defines a capacity in which the user 104 uses the computing device 106 and/or the access the user 104 is given to content while operating under the first persona 108. The second persona 110 defines a capacity in which the user 104 uses the computing device 106 and/or the access the user 104 is given to content while operating under the second persona 110.

When the example first persona 108 uses the example computing device 106, the example content manager 102 enables the example computing device 106 to access content associated with the first persona 108. Content associated with the first persona 108 is illustrated generally in FIG. 1 as example first unencrypted persona content 112, in which the example first unencrypted persona content 112 includes first unencrypted content portion 112a and second unencrypted content portion 112b. While the illustrated example of FIG. 1 includes two portions (i.e., first unencrypted content portion 112a and second unencrypted content portion 112b) of first unencrypted persona content 112, example methods, systems, apparatus and/or articles of manufacture disclosed herein may include any number of portions of content.

When the example second persona 110 uses the example computing device 106, the example content manager 102 enables the example computing device 106 to access content associated with the second persona 110. Content associated with the second persona 110 is illustrated generally in FIG. 1 as second unencrypted persona content 114, in which the example second unencrypted persona content 114 includes third unencrypted content portion 114a and fourth unencrypted content portion 114b.

In some examples, content is shared by two or more persona types. In other words, content is protected (e.g., using encryption), but the computing device 106, when the two or more persona types are active, may be able to access the protected content. In some examples, other content may be accessed by any persona and/or any user accessing the computing device. For example, general content 118 may be accessed by the computing device 106 regardless of any current persona type detected by the example persona manager 107, in which the general content 118 is unprotected (e.g., not encrypted).

The example content manager 102 protects content (e.g., first persona content 112, second persona content 114, etc.) from access by unauthorized users of the example computing device 106 based on a currently detected persona. For example, the content manager 102 protects the first persona content 112 from access by the user 104 when the second persona 110 is active on the computing device 106, and protects the second persona content 114 from access by the user 104 when the first persona 108 is active on the computing device 106. To protect the first persona content 112 and the second persona content 114, the example content manager 102 encrypts the first persona content 112 and the second content 114. Encryption involves encoding information such that unauthorized parties cannot access and/or interpret the encoded information. Any desired type of encryption protocol may be used (e.g., data encryption standard (DES), etc.).

The example content manager 102 of FIG. 1 encrypts one or more portions of the first persona content 112, such as each of the first unencrypted content portion 112a and the second unencrypted content portion 112b with a first unencrypted content key 120a (CK1) and a second unencrypted content key 120b (CK2), respectively. As a result of encrypting the first unencrypted content portion 112a with the first unencrypted content key 120a, first encrypted content portion 112c results. Similarly, as a result of encrypting the second unencrypted content portion 112b with the second unencrypted content key 120b, second encrypted content portion 112d results. The first unencrypted content key 120a and the second unencrypted content key 120b may be referred to generally as first unencrypted persona content keys 120. In some examples, the first unencrypted content key 120a (CK1) and the second unencrypted content key 120b (CK2) are identical, while in other examples they are uniquely associated with first unencrypted content portion 112a and second unencrypted content portion 112b. In still other examples, each of the first unencrypted persona content keys 120 are generated with a unique and/or otherwise random key value each time a corresponding file is saved by the user 104 of the example computing device 106.

The example content manager 102 encrypts each of the third unencrypted content portion 114a and the fourth unencrypted content portion 114b, each associated with the example second persona 110, with a third unencrypted content key 122a (CK3) and a fourth unencrypted content key 122b (CK4), respectively. As a result of encrypting the third unencrypted content portion 114a with the third unencrypted content key 122a (CK3), third encrypted content portion 114c results. Similarly, as a result of encrypting the fourth unencrypted content portion 114b with the fourth unencrypted content key 122b (CK4), fourth encrypted content portion 114d results. The third unencrypted content key 122a and the fourth unencrypted content key 122b may be referred to generally as second unencrypted persona content keys 122. In the illustrated example of FIG. 1, the first unencrypted persona content keys 120 and the second unencrypted persona content keys 122 are symmetrical keys. Thus, the first unencrypted persona content keys 120 (i.e. the first unencrypted content key 120a and the second unencrypted content key 120b) and the second unencrypted persona content keys 122 (i.e., the third unencrypted content key 122a and the fourth unencrypted content key 122b) are used to both encrypt and decrypt the first unencrypted persona content 112 and the second unencrypted persona content 114, respectively. While the example first unencrypted persona content keys 120 facilitate encryption of the first unencrypted persona content 112, which may originally exist in a clear text (unencrypted) state/format, the first unencrypted persona content keys 120 are not, themselves, initially encrypted. As such, in the event the first unencrypted persona content keys 120 are ever made public, then any content encrypted by those keys is at risk of unauthorized decryption if they are symmetric keys. A similar concern exists for the example unencrypted persona content keys 122.

Thus, to protect the first unencrypted persona content keys 120 and the second unencrypted persona content keys 122, the example content manager 102 encrypts the first unencrypted persona content keys 120 and the second unencrypted persona content keys 122 by using public keys associated with each corresponding persona of interest. For example, the content manager 102 uses a first public encryption persona key 124 (PUB₁) to encrypt the first unencrypted content key 120a to generate a first encrypted content key 120c (CK1′). The first public encryption persona key 124 (PUB₁) is public, meaning that a public device may access PUB₁ 124. However, a public device may not access information protected (e.g., encrypted) by PUB₁ 124 without a corresponding first private decryption persona key 128 (PRIV₁). Thus, if the first persona content keys 120 are encrypted with PUB₁ 124, then a public device may not access the first persona content keys 120 without PRIV₁ 128.

The example first encrypted content key 120c is added to the example first encrypted content portion 112c as first metadata 150 (see dashed arrow A). This allows the example first encrypted content portion 112c to be freely distributed and/or otherwise disclosed without concern for unauthorized access to either the first unencrypted content portion 112a and/or the first unencrypted content key 120a (CK1). A similar manner of protecting second unencrypted content portion 112b, the third unencrypted content portion 114a and the fourth unencrypted content portion 114b are shown in the illustrated example of FIG. 1 having corresponding second metadata 152 (see dashed arrow B), third metadata 154 (see dashed arrow C) and fourth metadata 156 (see dashed arrow D). Unless the computing system 106 has access to a first private decryption persona key 128 (PRIV₁), which compliments the example first public encryption persona key 124 (PUB₁), the example first encrypted content key 120c (CK1′) cannot be decrypted to expose the example first unencrypted content key 120a (CK1). Generally speaking, a public key is associated with a corresponding private key. While the public key may be readily available to any party in a public manner, the corresponding private key is not disclosed and/or otherwise available in a public manner. In the event the public key is used for encryption purposes, then the only key capable of decryption is by the corresponding private key.

While the illustrated example of FIG. 1 above includes a manner of protecting the first unencrypted content portion 112a, example methods, apparatus, systems and/or articles of manufacture disclosed herein may protect any number of content portions for one or more different personas. For each persona of interest, the example content manager generates and/or otherwise establishes a corresponding public key and private key. The example PUB₁ 124 and the example PRIV₁ 128 form a first public/private key pair 158 corresponding to the first persona 108, and an example second public encryption persona key (PUB₂) 126 and an example second private decryption persona key (PRIV₂) 130 form a second public/private key pair 160 corresponding to the second persona 110.

When a user (e.g., the user 104) uses the example computing device 106, the content manager 102 of the illustrated example identifies the active persona associated with the user (e.g., the example persona manager 107 determines an active persona associated with first persona 108). In some examples, and as disclosed in U.S. patent application Ser. No. 13/630,076, the persona manager 107 communicatively connected to the content manager 102 detects active personas and/or changes in active personas by collecting user identification data using an identification device reader such as a radio frequency identification tag reader, a smart card reader, etc. In some examples, the persona manager 107 detects active personas and/or changes in active personas by collecting user identification data using a biometric sensor, a face recognition sensor, a behavioral analysis sensor, a camera, a microphone, a fingerprint reader, a palm reader, a retinal scanner, a face recognition system, a voice recognition system, a Deoxyribonucleic acid (DNA) analysis system, etc. In some examples, the persona manager 107 detects active personas and/or changes in active personas using facial detection or recognition, vein detection or recognition, heartbeat analysis, etc. In still other examples, the persona manager 107 detects active personas and/or changes in active personas based on usage characteristic data such as data representative of time of day (e.g., works hours, evening hours, etc.), day of the week, holidays, location (work location, home location, etc.), secondary device proximity, etc. Secondary device proximity may include, for example, detection of an employer-provided mobile device near the computing device, detection of a home telephone and/or television near the computing device, etc.

Once the active persona is determined (e.g., determined by the content manager 102 by receipt of a current persona state from the example persona manager 107), the example content manager 102 permits access to the private decryption persona key associated with the detected active persona and blocks access to the private decryption persona key(s) associated with one or more personas that are not currently active. For example, in response to a file access attempt for the first encrypted content portion 112c while the first persona 108 is active, the content manager 102 extracts the attached first metadata 150. If the first metadata 150 includes an encrypted content key that is associated with the currently active persona of the example computing device 106, then the corresponding private key is authorized by the content manager 102 for decryption of the encrypted content key. As discussed above, decryption of the encrypted content key, such as the example first encrypted content key 120c (CK1′) results in access to the unencrypted content key 120a (CK1). With access to the unencrypted content key 120a (CK1), the example content manager 102 decrypts the example encrypted content portion 112c to reveal and/or otherwise access the example unencrypted content portion 112a.

On the other hand, in response to a file access attempt for the first encrypted content portion 112c while the second persona 110 is active, the content manager 102 extracts the attached first metadata 150. Because the example computing device is operating in a mode associated with the second persona 110, the example content manager 102 only provides authorization to use PRIV₂ 130, but blocks and/or otherwise prohibits authorization or access to use PRIV₁ 128. As a result, the example encrypted content portion 112c cannot be decrypted by the example computing device 106 to enable access to the example encrypted content portion.

Because PRIV₁ 128 and the first persona content keys 120 enable functional access to the first persona content 112 and do not enable functional access to the second persona content 114, the computing device 106 is unable to access the second persona content 114 while the first persona 108 is active. In other words, the content manager 102 restricts and/or blocks access to the second persona content 114 while the first persona 108 is actively associated with the computing device 106.

In some examples, the content manager 102 receives and/or otherwise retrieves an indication that a different active persona is associated with the computing device 106. For example, the content manager 102 determines that the second persona 110 is active. When the content manager 102 identifies a different active persona is using the computing device 106, the content manager 102 makes the private decryption persona key for the previous persona unavailable so that the newly active persona cannot access the content associated with the previous persona. For example, when the content manager 102 receives and/or otherwise retrieves the indication (e.g., from the persona manager 107) that the second persona 110 is actively associated with the computing device 106, the content manager 102 makes PRIV₁ 128 unavailable so that the computing device 106 cannot access the first persona content keys 120 and, thus, cannot access the first persona content 112. In other words, the content manager 102 restricts and/or blocks access to PRIV₁ 128 so that the user associated with the second persona 110 cannot access the first content keys 120 and, thus, the first persona content 112 because the first persona content keys 120 cannot be decrypted without functional access to PRIV₁ 128.

Protecting content with content keys and protecting the content keys with persona keys also enables two or more personas to access the same content. To enable two or more personas to access content, the example content manager 102 updates the metadata associated with a file to be shared with an encrypted content key that was generated by encrypting an unencrypted content key with the new or alternate public encryption key associated with the new or alternate persona that is to have shared access to the file of interest. To illustrate, consider the example computing device 106 of the illustrated example of FIG. 1 to be in a mode associated with the second persona 110 when accessing the third encrypted content portion 114c. Originally, the example third encrypted content portion 114c only included the example third metadata 154, which included example third encrypted content key 122c (CK3′). As discussed above, the example third encrypted content key 122c (CK3′) was generated at a first instance in time by encrypting the example unencrypted content key 122a (CK3) with the second public key PUB₂ 126 (see solid arrow X). As such, at this first instance in time the example computing system 106 could not access the example unencrypted content portion 114a unless the example second persona 110 was active. In other words, the example third metadata 154 facilitates granting access to unencrypted content portion 114a when the second persona 110 is active, and facilitates blocking access to unencrypted content portion 114a when the first persona 108 is active.

To facilitate new and/or additional access to the example unencrypted content portion 114a for the first persona 108 at a second instance in time, the example content manager 102 generates a new encrypted content key from the same example unencrypted content key 122a (CK3) used at the first instance in time. However, at the second instance in time, the example content manager 102 uses the first public key PUB₁ 124 associated with the first persona 108 (see dashed arrow X′) to generate another separate encrypted content key (i.e., a fifth encrypted content key 122e (CK5′)) (see dashed arrow X″) In other words, the same unencrypted content key 122a (CK3) is encrypted on two separate occasions with two separate public keys to generate corresponding encrypted content keys (i.e., CK3′ and CK5′) to facilitate shared access to the unencrypted content portion 114a. Additionally, the example content manager embeds, combines and/or otherwise adds the example fifth encrypted content key 122e to the example third encrypted content portion 114c as fifth metadata 158 (see dashed arrow E). Because the example third encrypted content portion 114c now has third metadata 154 associated with the second persona 110, and fifth metadata 158 associated with the first persona 108, the example computing device 106 can access the example unencrypted content portion 114a when either the first persona 108 or the second persona 110 is active.

As disclosed above, because the example content manager 102 enables and disables one or more keys based on an indication of an active persona and/or indications of changed personas, access to particular content may be managed without cumbersome log-on and/or log-out actions. Additionally, example methods, apparatus, systems and/or articles of manufacture disclosed herein enable content access management without username and/or password entry by the user(s) of the computing device 106.

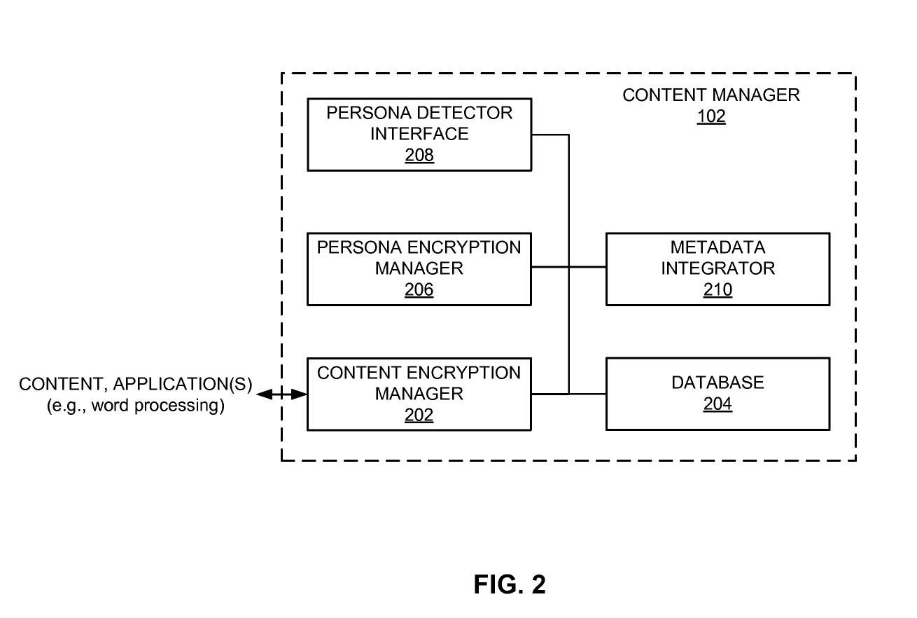

FIG. 2 is an illustration of an example implementation of the example content manager 102 of FIG. 1. The example content manager 102 provides persona aware content protection to enable different content access permissions (e.g., access to applications, programs and/or files) of the computing device 106 based on particular active personas (which may or may not be associated with the same human being). The content manager 102 of the illustrated example includes an example content encryption manager 202, an example key storage 204, an example persona encryption manager 206, an example persona detector interface 208, and an example metadata integrator 210.

In operation, the example content encryption manager 202 identifies whether the example computing device 106 generates a clear text file. For example, a user 104 of the computing device 106 may utilize a computing application, such as a word processing application, to generate content. In response to a save operation by the application, the example content encryption manager 202 applies a key for encrypting the clear text format of the content, such as an example persona content key (e.g., symmetric key). Additionally, the example persona detector interface 208 retrieves and/or otherwise receives an indication of the current persona with which the content is to be associated. The example persona content key used by the example content encryption manager 202 may be generated with, for example, a random number generator, or the example key storage 204 may contain any number of keys (e.g., symmetric keys) for each associated persona of interest. Additionally, the example content manager 102 may operate as a secure system of the example computing device 106, thereby preventing file access queries of the example key storage 204 where one or more keys are securely stored. As such, content encrypted by the example persona content key may be stored in a computer file system, a network file system and/or a cloud-based storage location without concern for the user 104 of the computing device 106 accessing the key storage 204 for a copy of the example persona content key.

The example persona encryption manager 206 accesses the public key associated with the currently active persona, and applies the public key to the persona content key during an encryption operation. As described above, each public encryption persona key (e.g., PUB₁ 124, PUB₂ 126, etc.) is associated with a corresponding private decryption persona key (e.g., PRIV₁ 128, PRIV₂ 130, etc.). As such, even if the public encryption persona key is available to anyone, content and/or keys encrypted with the public encryption persona key can only be decrypted with the corresponding private decryption persona key, which is securely stored in the example key storage 204. Despite the example key storage 204 residing and/or otherwise operating within system resources of the example computing device 106, the secure configuration of the example content manager 102 prevents system resources (e.g., file manager, file explorer, etc.) from simply accessing the example key storage 204 and obtaining one or more keys. Instead, key operations for encryption and/or decryption occur within the example content manager 102.

As a result of the encryption of the unencrypted content key (e.g., the example first content key 120a of FIG. 1) with the public key (e.g., PUB₁ 124 associated with the first persona 108), an encrypted content key results (e.g., the example first encrypted content key 120c (CK1′) of FIG. 1). As described above, the encrypted content key is protected via encryption with a public key that can only be decrypted by a corresponding private key. One or more private keys associated with one or more personas to be active on the example computing device 106 may be hardware protected in the example key storage 204. The encrypted content key is attached to content previously encrypted (e.g., first encrypted content portion 112c of FIG. 1) by an unencrypted content key (e.g., the example first unencrypted content key 120a (CK1) of FIG. 1) as metadata (e.g., metadata 150 of FIG. 1). Generally speaking, the attached metadata allows the example metadata integrator 210 to initially analyze content access requests to determine whether the content is associated with a currently active persona of the computing device 106. If so, then the example metadata integrator 210 invokes further efforts to decrypt information contained within the encrypted content portion(s) (e.g., the example encrypted content portion 112c of FIG. 1).

In the event decryption functionality is requested by the example content manager 102, encrypted content (e.g., encrypted word processing files) may be obtained by the example content encryption manager 202 so that decryption operation(s) may be performed therein, and resulting clear text is returned by the requesting application (e.g., Microsoft® Word®). In response to receipt and/or retrieval of content by the example content encryption manager 202, the example metadata integrator 210 determines whether the content includes metadata attached thereto. If so, the example metadata integrator 210 determines whether the attached metadata is associated with the currently active persona. If not, the content is not processed further, but if the metadata is associated with the currently active persona, the example persona encryption manager 206 authorizes application of the corresponding private key to permit decryption of the encrypted content key attached as metadata. Decryption of the encrypted content key exposes the unencrypted content key that can be used by the content encryption manager 202 to decrypt the content and expose clear text for the user of the example computing device 106.

In other examples, if the example persona detector interface 208 receives and/or otherwise retrieves an indication that a current persona has changed, then the example content encryption manager 202 determines whether there is any currently opened content that is being used by the example computing device 106 and/or one or more applications executing on the example computing device 106. If so, the example content encryption manager 202 causes open content (e.g., applications, programs, and/or files in use on the computing device 106) to be terminated (e.g., closed). Terminating open content prior to making the private decryption persona keys unavailable allows content to be saved, content to be safely closed, etc. Clear text content is saved and the example content encryption manager 202 invokes a persona content key to encrypt the clear text content (e.g., via a symmetric key). The example persona encryption manager 206 revokes functional access to any private key(s) associated with the previous persona. When the prior content associated with the prior persona has been properly closed and/or stored, the example persona encryption manager 206 authorizes functional access to any private key(s) associated with the new persona based on the received and/or retrieved indication of the current persona from the example persona detector interface 208.

Keys may be stored in the example key storage 204 in a manner that is secure from direct access (e.g., via one or more hardware mechanisms, such as the Intel® Identity Protection Technology) by the example computing device 106 (e.g., via a file manager). In particular, while unencrypted symmetric keys are not released and/or otherwise made available outside of the example content manager 102, a symmetric key (e.g., the first unencrypted content key 120a (CK1)) that has been encrypted (e.g., the first encrypted content key 120c (CK1′)) with a public encryption persona key (e.g., PUB₁ 124, PUB₂ 126) may be publicly distributed without concern because such encrypted symmetric keys can only be decrypted via a corresponding private key (e.g., PRIV₁ 128, PRIV₂ 130). Additionally, the one or more private decryption persona key(s) are stored in the example key storage 204 and are not accessible by the example content encryption manager 202 and/or the example persona encryption manager 206 unless and until a corresponding persona indication is true. For example, in response to receiving and/or otherwise retrieving an indication from the example persona detector interface 208 that a first persona is active, the key storage will release functional access to PRIV₁ 128 for decryption purposes.

While an example manner of implementing the content manager 102 of FIG. 1 is illustrated in FIGS. 1 and 2, one or more of the elements, processes and/or devices illustrated in FIGS. 1 and/or 2 may be combined, divided, re-arranged, omitted, eliminated and/or implemented in any other way. Further, the example content encryption manager 202, the example key storage 204, the example persona encryption manager 206, the example persona detector interface 208, the example metadata integrator 310, and/or, more generally, the example content manager 102 of FIGS. 1 and 2 may be implemented by hardware, software, firmware and/or any combination of hardware, software and/or firmware. Thus, for example, any of the example content encryption manager 202, the example key storage 204, the example persona encryption manager 206, the example persona detector interface 208, the example metadata integrator 210, and/or, more generally, the example content manager 102 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example content encryption manager 202, the example key storage 204, the example persona encryption manager 206, the example persona detector interface 208, the example metadata integrator 210, and/or, more generally, the example content manager 102 is/are hereby expressly defined to include a tangible computer readable storage device or storage disk such as a memory, a digital versatile disk (DVD), a compact disk (CD), a Blu-ray disk, etc. storing the software and/or firmware. Further still, the example content manager 102 of FIGS. 1 and 2 may include one or more elements, processes and/or devices in addition to, or instead of, those illustrated in FIGS. 1 and 2, and/or may include more than one of any or all of the illustrated elements, processes and devices.

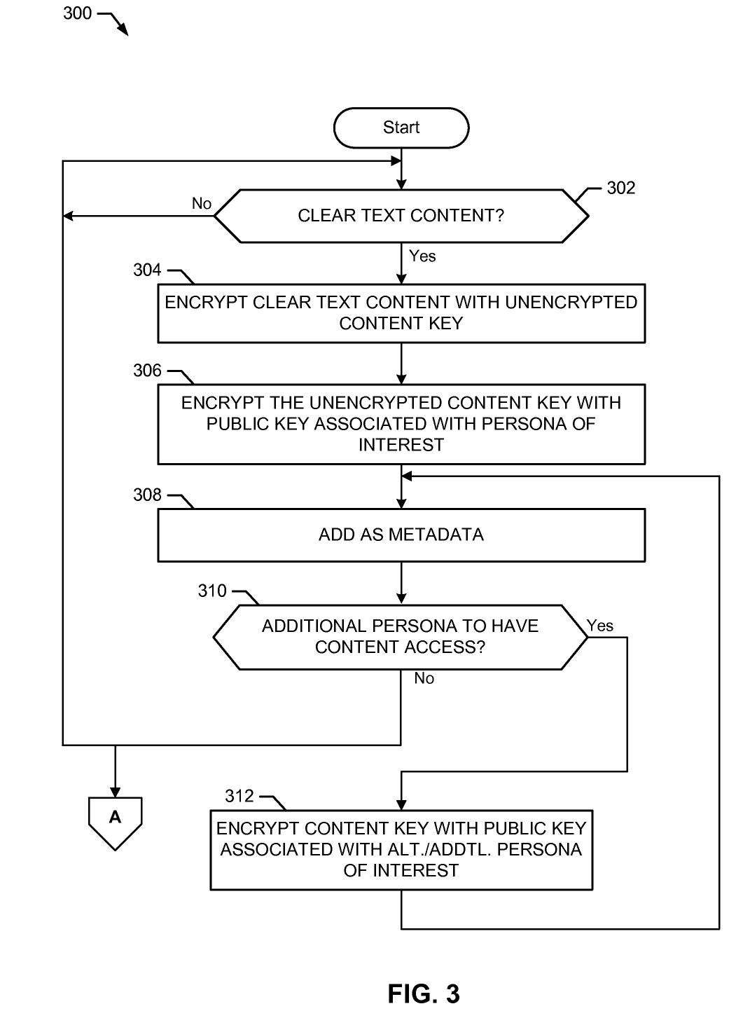

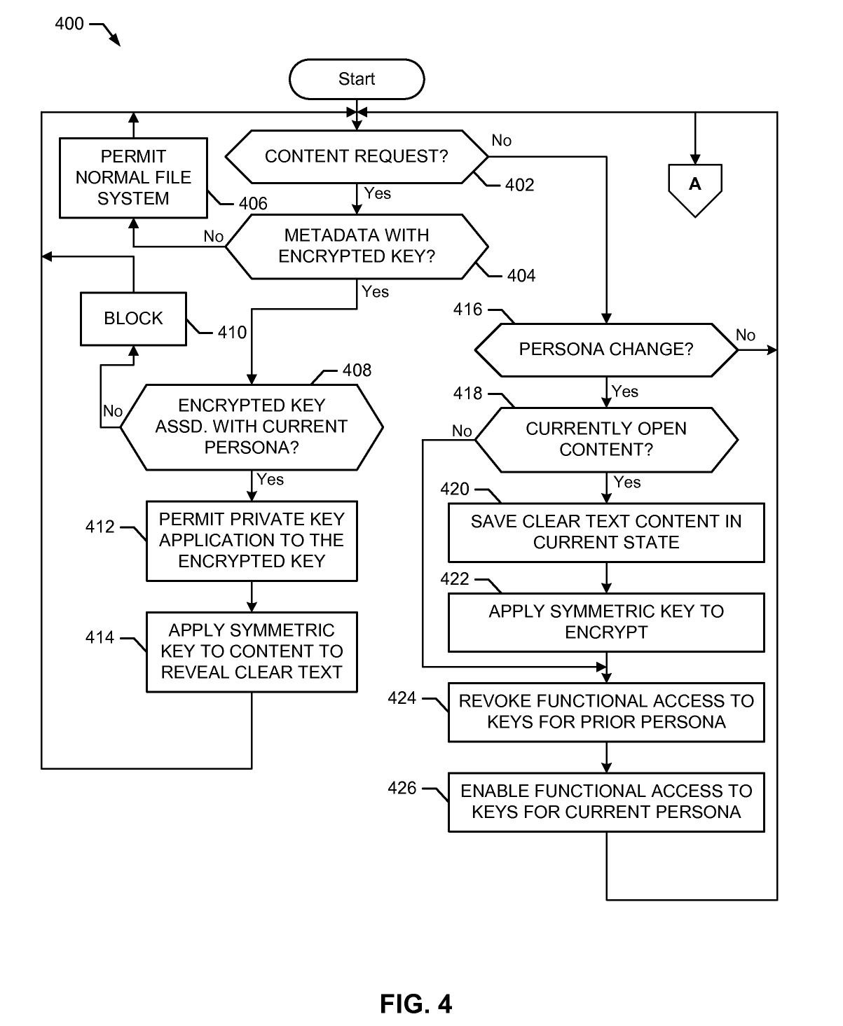

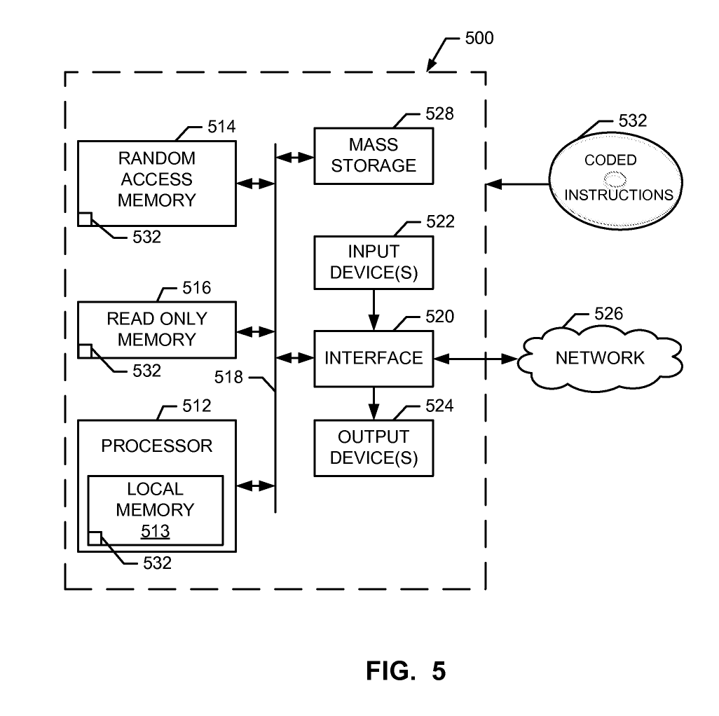

Flowcharts representative of example machine readable instructions for implementing the example content manager 102 of FIGS. 1 and/or 2, the example content encryption manager 202, the example key storage 204, the example persona encryption manager 206, the example persona detector interface 208, the example metadata integrator 210, and/or, more generally, the example content manager 102 are shown in FIGS. 3 and 4. In these examples, the machine readable instructions comprise programs for execution by a processor such as the processor 512 shown in the example processor platform 500 discussed below in connection with FIG. 5. The programs may be embodied in software stored on a tangible computer readable storage medium such as a CD-ROM, a floppy disk, a hard drive, a digital versatile disk (DVD), a Blu-ray disk, or a memory associated with the processor 512, but the entire programs and/or parts thereof could alternatively be executed by a device other than the processor 512 and/or embodied in firmware or dedicated hardware. Further, although the example programs are described with reference to the flowcharts illustrated in FIGS. 3 and 4, many other methods of implementing the example content encryption manager 202, the example key storage 204, the example persona encryption manager 206, the example persona detector interface 208, the example metadata integrator 210, and/or, more generally, the example content manager 102 may alternatively be used. For example, the order of execution of the blocks may be changed, and/or some of the blocks described may be changed, eliminated, or combined.

As mentioned above, the example processes of FIGS. 3 and 4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals, and to exclude transmission media. As used herein, “tangible computer readable storage medium” and “tangible machine readable storage medium” are used interchangeably. Additionally or alternatively, the example processes of FIGS. 3 and 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The example program 300 of FIG. 3 illustrates an example process implemented by the content manager 102 to protect content based on persona. In the illustrated example of FIG. 3, the example content encryption manager 202 monitors for an instance of content creation (block 302). Content creation may include word processing documents generated by a word processing application, spreadsheet documents generated by a spreadsheet application, financial documents generated by a financial management application and/or any type of content generated by one or more application(s) (e.g., executable programs) that execute on the example computing device 106. If content creation does not occur (block 302), the example content encryption manager 202 continues to monitor for an instance of content creation on the example computing device 106.

In response to an indication of content creation (block 302), such as an attempt to save a file to a memory of the computing device 106, the example persona detector interface 208 is queried by the example persona encryption manager 206 to determine a currently active persona and encrypts a clear text file with an unencrypted content key (block 304). As described above, the example unencrypted content key may be a symmetric key generated by the example persona encryption manager 206 to be used with the currently active persona when encrypting content. However, because the example unencrypted content key is initially not encrypted, any release of the unencrypted content key from the confines of the example content manager 102 and/or the example key storage 204 of the content manager 102 would cause added risk to the security of any documents encrypted by the unencrypted content key. To minimize or eliminate a security risk of the unencrypted content key being discovered and/or otherwise obtained by a third party, the example persona encryption manager 206 encrypts the unencrypted content key with a public key that is associated with the currently active persona (block 306). As such, the resulting encrypted content key cannot be used by a third party unless a private key corresponding to the previously used encryption key is applied for decryption purposes.

The example metadata integrator 210 adds the encrypted content key to the encrypted content as metadata (block 308) so that future access attempts of the encrypted content can be managed for decryption operation(s). In the event one or more additional personas are to also have access to the encrypted content (block 310), then the example persona encryption manager 206 encrypts the same unencrypted content key with a separate public key associated with the additional persona (block 312). The newly encrypted content key based on the common unencrypted content key is added to the encrypted content as metadata (block 308) by the example metadata integrator 210. As described above in connection with FIG. 1, example third encrypted content portion 114c includes example third metadata 154 as example fifth metadata 158. Because the example third metadata 154 is associated with the example second persona 110, the unencrypted content portion 114a is accessible to a user of the computing device 106 when the second persona 110 is active. Similarly, because the example fifth metadata 158 is associated with the example first persona 108, the unencrypted content portion 114a is accessible to a user of the computing device 106 when the first persona 108 is active. In the event no additional persona types are to have access to the encrypted content (block 310), control returns to block 302 to monitor for additional instances of content access attempt(s).

While the illustrated example program 300 of FIG. 3 describes a manner of protecting new content after it is created by an active persona, the illustrated example program 400 of FIG. 4 describes an example process to grant or deny access to content based on a currently active persona. In the illustrated example of FIG. 4, the example content encryption manager 202 monitors for a request for content access (block 402). A content request may occur in response to an application executing on the example computing device 106 making a request for a file from a memory. In some examples, the content manager 102 is implemented as an application programming interface (API) to monitor for instances of memory and/or storage read and write access attempts. In response to a request for content and/or an access attempt of content (e.g., a file) (block 402), the example metadata integrator 210 determines whether the content includes metadata with an encrypted key (block 404). If not, then further access attempts are handled by a standard file system of the example computing device 106 (block 406) and control returns to block 402. On the other hand, if the metadata includes an encrypted key (block 404), the example metadata integrator 210 invokes the example persona detector interface 208 to determine a current persona type, and if the encrypted key is not associated with the current persona, further access attempts to the requested content are blocked (block 410).

If the encrypted key is associated with the currently active persona (block 408), the example metadata integrator 210 invokes the example key storage 204 to release the private key to the example content encryption manager 202 to initiate decryption of the example encrypted content key (block 412). After the example content encryption manager 202 employs the private key to decrypt the encrypted content key (block 412), the example content encryption manager 202 now has access to the unencrypted symmetric key that was originally used to encrypt the content. That same symmetric key is used by the example content encryption manager 202 to decrypt the content to reveal a clear text version (block 414). Control then returns to either block 402 to monitor for one or more additional requests for clear text access, or control returns to block 302 of FIG. 3 to monitor for a request to store clear text on the example computing device 106, such as a request to store an updated version of the clear text recently provided to the application executing on the example computing device 106.

In the event that a request for content does not occur (block 402), the example persona detection interface 208 determines whether the currently active persona has changed (block 416). If no indication of a change of the current persona is identified (block 416), then control returns to block 402 and/or 302 to monitor for a content retrieval request or a content storage request, respectively. On the other hand, a user of the computing device may have been in proximity to one or more routers associated with the first persona 108, but later left that location for a second location with one or more routers associated with the second persona 110 (e.g., a consultant that left a first work site for a second work site). As a result, the example persona detection interface 208 may indicate a change in persona (block 416) and invoke the example content encryption manager 202 to determine whether there is any currently opened content (block 418). If so, the example content encryption manager 202 saves the open content in its current state (block 420) and applies the symmetric key to encrypt the clear text content into encrypted content that can be safely stored in a memory of the computing device 106 (block 422).

To prevent the computing device 106 from having access capabilities to content associated with a previous persona state, the example persona encryption manager 206 revokes functional access to one or more keys that are associated with the previous persona state (block 424), such as a private key associated with the previous persona. On the other hand, to permit the computing device 106 to facilitate access to content associated with the new persona state, the example persona encryption manager 206 authorizes functional access to one or more keys that are associated with the new persona state (block 426). Control then returns to block 402.

FIG. 5 is a block diagram of an example processor platform 500 capable of executing the instructions of FIGS. 3 and/or 4 to implement the example content manager 102 of FIGS. 1 and/or 2. The processor platform 500 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 500 of the illustrated example includes a processor 512. The processor 512 of the illustrated example is hardware. For example, the processor 512 can be implemented by one or more integrated circuits, logic circuits, microprocessors or controllers from any desired family or manufacturer.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, one or more input devices 522 are connected to the interface circuit 520. The input device(s) 522 permit(s) a user to enter data and commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 520 of the illustrated example, thus, typically includes a graphics driver card, a graphics driver chip or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes one or more mass storage devices 528 for storing software and/or data. Examples of such mass storage devices 528 include floppy disk drives, hard drive disks, compact disk drives, Blu-ray disk drives, RAID systems, and digital versatile disk (DVD) drives.

The coded instructions 532 of FIGS. 3 and/or 4 may be stored in the mass storage device 528, in the volatile memory 514, in the non-volatile memory 516, and/or on a removable tangible computer readable storage medium such as a CD or DVD.

An example disclosed system includes a content encryption manager to encrypt a first content with an unencrypted first content key in response to identifying a first persona mode of a computing device, a persona encryption manager to encrypt the unencrypted first content key with a first public key to generate an encrypted first content key, and a metadata integrator to embed the encrypted first content key into the encrypted first content. Other example disclosed systems include the first public key is associated with a first private key, and wherein the persona encryption manager is to enable use of the first private key to decrypt the encrypted first content key in response to identifying the first persona mode of the computing device. Some example disclosed systems include decrypting the encrypted first content key results in an unencrypted symmetric key, wherein the content encryption manager is to decrypt the first content using the unencrypted symmetric key. Still other example disclosed systems include the persona encryption manager to block use of a second private key associated with a second persona mode of the computing device when the first persona mode is active. Some example disclosed systems include a persona detector interface to identify an indication of a change from the first persona mode of the computing device to a second persona mode of the computing device, wherein the content encryption manager is to save the first content to a storage location in response to receiving the indication of change. Still other example systems disclosed herein include the content encryption manager to apply the unencrypted first content key to the first content in the storage location to encrypt the first content, wherein the persona encryption manager is to revoke usage access of a first private key associated with the first persona mode after the encrypted first content is saved in the storage location. Some example systems disclosed herein include the persona encryption manager to permit usage access of a second private key associated with the second persona mode after the encrypted first content is saved in the storage location. Still other example systems disclosed herein include the persona encryption manager to encrypt the unencrypted first content key with a second public key to generate an encrypted second content key, wherein the first content is shared between the computing device in the first persona mode and the computing device in the second persona mode by, decrypting the encrypted first content key with a first private key associated with the first persona mode to obtain the unencrypted first content key, and by decrypting the second content key with a second private key associated with the second persona mode to obtain the unencrypted first content key.

An example disclosed method includes encrypting a first content with an unencrypted first content key in response to identifying a first persona mode of a computing device, encrypting the unencrypted first content key with a first public key to generate an encrypted first content key, and embedding the encrypted first content key into the encrypted first content. Some example disclosed methods include associating the first public key with a first private key, and enabling use of the first private key to decrypt the encrypted first content key in response to identifying the first persona mode of the computing device. Still other example disclosed methods include decrypting the first content using an unencrypted symmetric key generated by decrypting the first content key, and blocking use of a second private key associated with a second persona mode of the computing device when the first persona mode is active. Other example disclosed methods include identifying an indication of change from the first persona mode of the computing device to a second persona mode of the computing device, and saving the first content to a storage location in response to receiving the indication of change. Still other example disclosed methods include applying the unencrypted first content key to the first content in the storage location to encrypt the first content, and revoking usage access of a first private key associated with the first persona mode after the encrypted first content is saved in the storage location. Some example disclosed methods include permitting usage access of a second private key associated with the second persona mode after the encrypted first content is saved in the storage location, while still other example disclosed methods include encrypting the unencrypted first content key with a second public key to generate an encrypted second content key, and sharing the first content between the computing device in the first persona mode and the computing device in the second persona mode by decrypting the encrypted first content key with a first private key associated with the first persona mode to obtain the unencrypted first content key, and by decrypting the second content key with a second private key associated with the second persona mode to obtain the unencrypted first content key.

An example disclosed computer readable storage medium includes encrypting a first content with an unencrypted first content key in response to identifying a first persona mode of a computing device, encrypting the unencrypted first content key with a first public key to generate an encrypted first content key, and embedding the encrypted first content key into the encrypted first content. Some example disclosed instructions include associating the first public key with a first private key, and enabling use of the first private key to decrypt the encrypted first content key in response to identifying the first persona mode of the computing device. Still other example disclosed instructions include decrypting the first content using an unencrypted symmetric key generated by decrypting the first content key, and blocking use of a second private key associated with a second persona mode of the computing device when the first persona mode is active. Other example disclosed instructions include identifying an indication of change from the first persona mode of the computing device to a second persona mode of the computing device, and saving the first content to a storage location in response to receiving the indication of change. Still other example disclosed instructions include applying the unencrypted first content key to the first content in the storage location to encrypt the first content, and revoking usage access of a first private key associated with the first persona mode after the encrypted first content is saved in the storage location. Some example disclosed instructions include permitting usage access of a second private key associated with the second persona mode after the encrypted first content is saved in the storage location, while still other example disclosed instructions include encrypting the unencrypted first content key with a second public key to generate an encrypted second content key, and sharing the first content between the computing device in the first persona mode and the computing device in the second persona mode by decrypting the encrypted first content key with a first private key associated with the first persona mode to obtain the unencrypted first content key, and by decrypting the second content key with a second private key associated with the second persona mode to obtain the unencrypted first content key.

An example disclosed system to protect content includes means for encrypting a first content with an unencrypted first content key in response to identifying a first persona mode of a computing device, means for encrypting the unencrypted first content key with a first public key to generate an encrypted first content key, and means for embedding the encrypted first content key into the encrypted first content. In some examples disclosed herein, the system includes the first public key is associated with a first private key, and means for enabling use of the first private key to decrypt the encrypted first content key in response to identifying the first persona mode of the computing device, wherein the means for decrypting the encrypted first content key results in an unencrypted symmetric key. In still other examples, the means for encrypting the first content is to decrypt the first content using the unencrypted symmetric key. Some example systems include means for blocking use of a second private key associated with a second persona mode of the computing device when the first persona mode is active, and other example systems disclosed herein include means for identifying an indication of a change from the first persona mode of the computing device to a second persona mode of the computing device, which may further include means for saving the first content to a storage location in response to receiving the indication of change, and/or means for applying the unencrypted first content key to the first content in the storage location to encrypt the first content. In still other examples disclosed herein, the system includes means for revoking usage access of a first private key associated with the first persona mode after the encrypted first content is saved in the storage location, and means for permitting usage access of a second private key associated with the second persona mode after the encrypted first content is saved in the storage location. Some disclosed systems include means for encrypting the unencrypted first content key with a second public key to generate an encrypted second content key and means to share between the computing device in the first persona mode and the computing device in the second persona mode by decrypting the encrypted first content key with a first private key associated with the first persona mode to obtain the unencrypted first content key, and decrypting the second content key with a second private key associated with the second persona mode to obtain the unencrypted first content key.

Examples disclosed herein protect content based on personas associated with a computing device and enable dynamic changes in computing device and/or content access privileges based on detected personas without requiring manual log-in and/or log-out activities by the user, and without requiring expensive and/or resource intensive virtualization techniques (e.g., eliminates computing device operating system isolation).

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

1. A system to protect content, comprising:
a content encryption manager to encrypt a first content with an unencrypted first content key in response to identifying a first persona mode of a computing device;
a persona encryption manager to encrypt the unencrypted first content key with a first public key to generate an encrypted first content key; and
a metadata integrator to embed the encrypted first content key into the encrypted first content.

2. A system as defined in claim 1, wherein the first public key is associated with a first private key.

3. A system as defined in claim 2, wherein the persona encryption manager is to enable use of the first private key to decrypt the encrypted first content key in response to identifying the first persona mode of the computing device.

4. A system as defined in claim 3, wherein decrypting the encrypted first content key results in an unencrypted symmetric key.

5. A system as defined in claim 4, wherein the content encryption manager is to decrypt the first content using the unencrypted symmetric key.

6. A system as defined in claim 2, wherein the persona encryption manager is to block use of a second private key associated with a second persona mode of the computing device when the first persona mode is active.

7. A system as defined in claim 1, further comprising a persona detector interface to identify an indication of a change from the first persona mode of the computing device to a second persona mode of the computing device.

8. A system as defined in claim 7, wherein the content encryption manager is to save the first content to a storage location in response to receiving the indication of change.

9. A system as defined in claim 1, wherein the persona encryption manager is to encrypt the unencrypted first content key with a second public key to generate an encrypted second content key.

10. A system as defined in claim 9, wherein the first content is shared between the computing device in the first persona mode and the computing device in the second persona mode by:
decrypting the encrypted first content key with a first private key associated with the first persona mode to obtain the unencrypted first content key; and
decrypting the second content key with a second private key associated with the second persona mode to obtain the unencrypted first content key.

11. (canceled)

12. A method to protect content, comprising:
encrypting a first content with an unencrypted first content key in response to identifying a first persona mode of a computing device;
encrypting the unencrypted first content key with a first public key to generate an encrypted first content key; and
embedding the encrypted first content key into the encrypted first content.

13. A method as defined in claim 12, further comprising associating the first public key with a first private key.

14. A method as defined in claim 13, further comprising blocking use of a second private key associated with a second persona mode of the computing device when the first persona mode is active.

15. A method as defined in claim 12, further comprising identifying an indication of change from the first persona mode of the computing device to a second persona mode of the computing device.

16. A method as defined in claim 12, further comprising encrypting the unencrypted first content key with a second public key to generate an encrypted second content key.

17. A method as defined in claim 16, further comprising sharing the first content between the computing device in the first persona mode and the computing device in the second persona mode by:
decrypting the encrypted first content key with a first private key associated with the first persona mode to obtain the unencrypted first content key; and
decrypting the second content key with a second private key associated with the second persona mode to obtain the unencrypted first content key.

18. (canceled)

19. A computer readable storage device or storage disk having instructions stored thereon that, when executed, cause a machine to, at least:
encrypt a first content with an unencrypted first content key in response to identifying a first persona mode of a computing device;
encrypt the unencrypted first content key with a first public key to generate an encrypted first content key; and
embed the encrypted first content key into the encrypted first content.

20. A storage device or storage disk as defined in claim 19, wherein the instructions cause the machine to associate the first public key with a first private key.

21. A storage device or storage disk as defined in claim 20, wherein the instructions cause the machine to enable use of the first private key to decrypt the encrypted first content key in response to identifying the first persona mode of the computing device.

22. A storage device or storage disk as defined in claim 21, wherein the instructions cause the machine to decrypt the first content using an unencrypted symmetric key generated by decrypting the first content key.

23. A storage device or storage disk as defined in claim 20, wherein the instructions cause the machine to block use of a second private key associated with a second persona mode of the computing device when the first persona mode is active.

24. A storage device or storage disk as defined in claim 19, wherein the instructions cause the machine to identify an indication of change from the first persona mode of the computing device to a second persona mode of the computing device.

25. A storage device or storage disk as defined in claim 24, wherein the instructions cause the machine to save the first content to a storage location in response to receiving the indication of change.
